(19) United States
(12) Patent Application Publication
(10) Pub. No.: US 2016/0046515 A1
(43) Pub. Date: Feb. 18, 2016

(54) METHOD FOR PREVENTING SCALE DEPOSITION AND SCALE INHIBITOR

(71) Applicant: KURITA WATER INDUSTRIES LTD., Tokyo (JP)

(72) Inventor: Ikuko NISHIDA, Tokyo, (JP)

(21) Appl. No.: 14/778,846

(22) PCT Filed: Mar. 18, 2014
(86) PCT No.: PCT/JP2014/057246

§ 371 Date: Sep. 21, 2015

(30) Foreign Application Priority Data
Mar. 22, 2013 (JP) 2013-059451

(51) Int. Cl. C02F 5/10; C08F 222/10; C02F 1/44

(52) U.S. Cl. CPC C02F 5/10; C02F 1/441; C08F 222/10; C02F 2101/14

(57) ABSTRACT

An object of the invention is to provide a method for preventing scale deposition that can prevent deposition of calcium fluoride scale without increasing phosphorus concentration in a fluorine-containing water system. Provided is a method for preventing scale deposition comprising adding a phosphorus-free maleic acid/ethyl acrylate/vinyl acetate copolymer to a fluorine-containing water system. The phosphorus-free copolymer is preferably a polymer obtained by copolymerization of monomer components containing maleic acid at a rate of 60 mol % or more, ethyl acrylate, and vinyl acetate. It preferably has a weight-average molecular weight of 500 to 5000.

### TECHNICAL FIELD

The present invention relates to a method for preventing scale deposition and a scale inhibitor. More specifically, it relates to a method for preventing deposition of calcium fluoride scale in a fluorine-containing water system and a scale inhibitor.

### BACKGROUND ART

There are observed scale deposition troubles on the surface of heat-transfer tubes, piping, or membranes in contact with water in cooling water systems, boiler water systems, and membrane treatment systems or in reinjection wells for geothermal power plants. When such a system is operated at high concentration for conservation of resources and energy or when the recovery rate is raised in the case of membrane treatment, salts dissolved in water are concentrated and form scale of scarcely-soluble salts.

For example, scale formed in heat exchange unit inhibits heat transfer, scale deposited in a pipe leads to decrease of flow rate, and scale deposited on membrane leads to decrease of flux. When the scale generated separates, it circulates in the system, leading to obstruction of pump, piping, and heat exchange units and, by these obstructions, to acceleration of scale deposition in the piping and heat exchange units. Similar phenomena can occur in the reinjection wells of a geothermal power plant.

Scale species formed in these water systems include calcium carbonate, calcium sulfate, calcium sulfite, calcium phosphate, calcium silicate, magnesium silicate, magnesium hydroxide, zinc phosphate, zinc hydroxide, basic zinc carbonate, and the like.

Scale inhibitors generally used for prevention of calcium-based scale deposition generally include inorganic polyphosphates such as sodium hexametaphosphate and sodium tripolyphosphate; phosphonic acids such as aminomethylphosphonic acid, hydroxyethylidenediphosphonic acid, and phosphonobutanetricarboxylic acid; and copolymers of a carboxyl group-containing monomer such as maleic acid, acrylic acid, or itaconic acid in combination with a vinyl monomer having, as needed, a sulfonic acid group or a nonionic vinyl monomer such as acrylamide, which is selected according to the desired water quality.

The inorganic polyphosphoric acids and the phosphonic acids used as the scale inhibitors described above contain phosphorus. Along with recent regulation on the phosphorus concentration in wastewater, there exists a need for a phosphorus-free scale inhibitor. Under the circumstance, phosphorus-free calcium carbonate scale inhibitors have been studied (for example, see Patent Documents 1 to 3).

For example in the method described in Patent Document 1, a copolymer of maleic acid and allylsulfonic acid is used as the scale inhibitor. Alternatively in the processing method described in Patent Document 2, a maleic acid/ethyl acrylate/styrene ternary copolymer having a mass-average molecular weight of 600 to 10000 is used as the scale inhibitor. Yet alternatively in the composition for treatment of water system described in Patent Document 3, a polymaleic acid having a mass-average molecular weight of 400 to 800 and an acrylic copolymer having a molecular weight of 800 to 9500 are used in combination.

Yet alternatively, Patent Document 4 proposes a method for treating water from semiconductor-producing process, comprising adding sodium hexametaphosphate, sodium tripolyphosphate, or a phosphonic acid-based compound to a fluoride ion-containing recovery water from a semiconductor-producing process and separating the recovery water with reverse osmosis membrane.

### CITATION LIST

### Patent Literatures

[Patent Document 1] JP-A No. H02-75396

[Patent Document 2] JP-A No. H02-115384

[Patent Document 3] JP-A No. H04-222697

[Patent Document 4] JP-A No. 2000-202445

### SUMMARY OF INVENTION

### Technical Problem

Recently for effective use of water resources, wastewater is more frequently recovered with reverse osmosis membrane and used. For example when a silicon material is treated with hydrogen fluoride in a factory utilizing a silicon material, such as a semiconductor or a substrate for photovoltaic power generation, the wastewater containing semiconductor wash water may contain fluorine. When a fluorine- and calcium-containing wastewater is recovered using a RO membrane, calcium fluoride scale is more easily formed in addition to calcium carbonate scale.

As described above, under regulation of phosphorus concentration in wastewater, there is a demand for a phosphorus-free scale inhibitor.

Accordingly, an object of the present invention is to provide a method for preventing scale deposition and a scale inhibitor that can prevent deposition of calcium fluoride scale in a fluorine-containing water system without increasing the phosphorus concentration in the wastewater.

### Solution to Problem

The inventors have studied intensively a method and an agent that can prevent deposition of these scales, taking into consideration that, if a wastewater contains fluorine, calcium carbonate scale and additionally calcium fluoride scale are formed easily in such a water system. As a result, the inventors have found that it is possible to prevent deposition of calcium fluoride and calcium carbonate scales effectively by adding a maleic acid/ethyl acrylate/vinyl acetate terpolymer to such a fluorine-containing water system and made the present invention.

Specifically, the present invention provides a method for preventing scale deposition comprising adding a phosphorus-free maleic acid/ethyl acrylate/vinyl acetate copolymer to a fluorine-containing water system.

As a phosphorus-free copolymer is added to a fluorine-containing water system according to the present invention, it is possible to prevent deposition of calcium fluoride scale without increasing the phosphorus concentration of the wastewater from the water system.

The copolymer for use is a polymer obtained by copolymerization of monomer components containing maleic acid at a rate of 60 mol % or more, ethyl acrylate, and vinyl acetate. In addition, the copolymer for use has a weight-average molecular weight in the range of 500 to 5000.

In the method for preventing scale deposition, the copolymer is preferably added to a fluorine-containing water system for reverse osmosis membrane treatment. For example when a wastewater containing fluorine and calcium is recovered using a reverse osmosis membrane, the method for preventing scale deposition according to the present invention may be applied.

The present invention also provides a scale inhibitor of a phosphorus-free maleic acid/ethyl acrylate/vinyl acetate copolymer that is added to a fluorine-containing water system.

### Advantageous Effects of Invention

The present invention provides a method for preventing scale deposition and a scale inhibitor that can prevent deposition of calcium fluoride scale in a fluorine-containing water system without increasing the phosphorus concentration in the wastewater.

### DESCRIPTION OF EMBODIMENTS

Hereinafter, favorable embodiments of the present invention will be described in detail. It should be understood that the present invention is not limited to the embodiments described below.

### <Scale Inhibitor>

First, the scale inhibitor according to this disclosure will be described.

The scale inhibitor disclosed herein is an agent added to a fluorine-containing water system and the major component thereof is a phosphorus-free copolymer. The copolymer is preferably a maleic acid/ethyl acrylate/vinyl acetate terpolymer (ternary copolymer) and contains substantially no phosphorus.

The water system to which the scale inhibitor disclosed herein is applied is not particularly limited, if it is a fluorine-containing water system, but preferably a water system containing both fluorine and calcium. Examples of desired water systems include fluorine-containing systems such as cooling water systems, boiler water systems, membrane treatment water systems, dust collector water systems, and the like.

When a silicon material is treated with hydrogen fluoride in a factory using a silicon material such as a semiconductor or a substrate for photovoltaic power generation, the wastewater containing semiconductor wash water may contain fluorine. Accordingly, the scale inhibitor disclosed herein is favorably used for treatment of the water recovered from a facility such as a silicon material-processing plant (e.g., wastewater and recovery water from semiconductor-producing process and substrate-producing process).

The scale inhibitor disclosed herein is used preferably in a water system for membrane treatment, more preferably in a water system for reverse osmosis membrane treatment, and still more preferably for recovery of a fluorine- and calcium-containing wastewater using reverse osmosis membrane (RO membrane).

The copolymer used for the scale inhibitor disclosed herein is prepared by copolymerizing monomer components containing maleic acid, ethyl acrylate, and vinyl acetate. Thus, the copolymer has maleic acid-derived constituent units, ethyl acrylate-derived constituent units, and vinyl acetate-derived constituent units.

The content (amount) of each component in the monomer components constituting the copolymer is not particularly limited, but the content of maleic acid is preferably 60 mol % or more of the entire monomer components.

The monomer components constituting the copolymer preferably contain maleic acid at a rate of 60 to 98 mol %, ethyl acrylate at a rate of 1 to 39 mol %, and vinyl acetate at a rate of 1 to 39 mol %.

The monomer components constituting the copolymer more preferably contain maleic acid at a rate of 64 to 90 mol %, ethyl acrylate at a rate of 3 to 33 mol %, and vinyl acetate at a rate of 3 to 33 mol %.

It is possible to produce more easily a scale inhibitor that can prevent calcium fluoride scale deposition effectively by using the components respectively in the content ranges described above in synthesis of the copolymer.

The copolymer for use is favorably a copolymer having a weight-average molecular weight of 500 to 5000. To produce a scale inhibitor that effectively prevents scale deposition, the copolymer preferably has a weight-average molecular weight of 1700 to 4000, more preferably 1800 to 3000, and still more preferably 1900 to 2500.

The term “weight-average molecular weight,” as used herein, is a weight-average molecular weight, as determined by gel permeation chromatography using sodium polyacrylate as standard substance.

The copolymer is not limited, if it is a phosphorus-free copolymer containing maleic acid, ethyl acrylate, and vinyl acetate. Although it is preferably a terpolymer containing these monomer component-derived constituent units, it may be a quarter- or higher-copolymer if it is within the range that does not deviate from the object of the present disclosure.

The production and polymerization methods for the copolymer are not particularly limited. The copolymer can be prepared, for example, by a polymerization method such as solution polymerization, suspension polymerization, emulsion polymerization, or bulk polymerization, using maleic acid, ethyl acrylate, and vinyl acetate respective in predetermined amounts.

The polymerization initiator used in polymerization for the copolymer may be an initiator properly selected from known peroxide initiators. Typical examples of the initiators for use include dibenzoyl peroxide, tert-butyl perbenzoate, dicumyl peroxide, tert-butyl hydroperoxide, tert-butyl peroxide, and the like. Polymerization in such a case may be carried out batchwise or continuously at a polymerization temperature, for example, in the range of 40 to 100° C. for a polymerization period, for example, in the range of 2 to 5 hours.

The copolymer can also be prepared by aqueous polymerization that is carried out in an aqueous medium. For example in the case of the aqueous polymerization, an aqueous solution or dispersion containing the monomer components constituting the copolymer is first prepared; the pH of the solution is adjusted, as needed; after substitution of the atmosphere with an inert gas, the mixture is heated to 50 to 100° C. and a water-soluble polymerization initiator is added thereto. Examples of the water-soluble polymerization initiators used then include azo compounds such as 2,2′-azobis(2-amidinopropane) dihydrochloride, azobis-N,N′-dimethylene isobutylamidine dihydrochloride, and 4,4′-azobis(4-cyanovaleric acid)-2-sodium; persulfate salts such as ammonium persulfate, sodium persulfate, and potassium persulfate; and peroxides such as hydrogen peroxide and sodium periodate.

The polymerization condition in the case of aqueous polymerization is not particularly limited, and the aqueous polymer solution or dispersion can be prepared, for example, by polymerizing the components for 2 to 6 hours and then cooling the resulting mixture. Polymerization for the copolymer can be carried out not only in an aqueous medium but also in a general organic solvent for example by solution polymerization, suspension polymerization, or emulsion polymerization.

The scale inhibitor disclosed herein may contain, in addition to the maleic acid/ethyl acrylate/vinyl acetate copolymer described above, other additives in the range that does not impair the object of the present disclosure. Examples of the other additives include slime-controlling agents, enzymes, bactericides, colorants, flavoring agents, water-soluble organic solvents, antifoams, and the like.

Examples of the slime-controlling agents favorably used include quaternary ammonium salts such as alkyldimethylbenzylammonium chlorides, chloromethyltrithiazoline, chloromethylisothiazoline, methyl isothiazoline, ethylaminoisopropylaminomethylthiotriazine, hypochlorous acid, hypobromous acid, a mixture of hypochlorous acid and sulfamic acid, and the like.

As described above in detail, the scale inhibitor disclosed herein contains a phosphorus-free maleic acid/ethyl acrylate/vinyl acetate copolymer as the active ingredient. Thus, the scale inhibitor disclosed herein can prevent deposition of calcium fluoride scale and calcium carbonate scale without increasing the phosphorus concentration in the wastewater from a fluorine-containing water system.

It seems that the scale inhibitor disclosed herein containing ethyl acrylate/vinyl acetate copolymer units increases the efficiency of dispersing scale particles generated in a fluorine-containing water system. It also seems that the high dispersing efficiency leads to preservation of the small size of the scale particles generated. Thus when fluorine-containing water, such as wastewater, to be treated is recovered with a RO membrane, it apparently prevents obstruction of the membrane surface of the RO membrane.

The above-mentioned copolymer having a weight-average molecular weight in the range of 1700 to 4000 (favorably 1800 to 3000) can prevent deposition of calcium fluoride and calcium carbonate scales more efficiently and is resistant to gelling and thus it is favorable as a scale inhibitor for use during RO membrane treatment.

### <Method for Preventing Scale Deposition>

Hereinafter, the method for preventing scale deposition of the present disclosure will be described.

The method for preventing scale deposition described herein comprises adding a scale inhibitor of a phosphorus-free maleic acid/ethyl acrylate/vinyl acetate copolymer to a fluorine-containing water system. It becomes possible by adding the scale inhibitor to a fluorine-containing water system to prevent deposition of calcium fluoride and calcium carbonate scales that may be generated in the fluorine-containing water system. The phosphorus-free copolymer used in the method for preventing scale deposition disclosed herein is identical with that described above in the section of the scale inhibitor disclosed herein.

The method of adding the scale inhibitor in the method for preventing scale deposition disclosed herein is not particularly limited, and the scale inhibitor may be added to the area where scale deposition is desirably prevented or upstream thereof. The amount of the scale inhibitor added is also not particularly limited and may be determined arbitrarily according to the desired water quality of the water system.

For example, the scale inhibitor disclosed herein is preferably added in the amount that gives a copolymer concentration of 0.01 to 100 mg/L. In water systems for RO membrane treatment wherein, for example, a fluorine-containing wastewater is recovered using RO membrane, it is more preferable, for prevention of obstruction on the membrane surface of RO and other membranes, to add the scale inhibitor disclosed herein in the amount giving a copolymer concentration of 0.1 to 10 mg/L.

In the method for preventing scale deposition disclosed herein, other scale inhibitors may also be added, as needed, in addition to the copolymer to the fluorine-containing water system. The other scale inhibitors may be added, as mixed with the copolymer, or separately.

Examples of the other scale inhibitors used in combination with the scale inhibitor disclosed herein include polymaleic acid, poly(meth)acrylic acid, maleic acid/(meth)acrylic acid copolymers, maleic acid/isobutylene copolymers, maleic acid/sulfonic acid copolymers, (meth)acrylic acid/sulfonic acid copolymers, (meth)acrylic acid/nonionic group-containing monomer copolymers, ternary acrylic acid/sulfonic acid/nonionic group-containing monomer copolymers, and the like. The term “(meth)acrylic,” as used herein, indicates that it contains both acrylic and methacrylic.

Examples of the “sulfonic acids” in the copolymer that can be used as the other scale inhibitor described above include vinylsulfonic acid, allylsulfonic acid, styrenesulfonic acid, isoprenesulfonic acid, 3-aryloxy-2-hydroxypropanesulfonic acid, 2-acrylamido-2-methylpropanesulfonic acid, 2-methacrylamido-2-methylpropanesulfonic acid, 4-sulfobutyl methacrylate, allyloxybenzenesulfonic acid, methallyloxybenzenesulfonic acid, metal salts thereof, and the like.

Examples of the “nonionic group-containing monomers” in the copolymer that can be used as the other scale inhibitor include alkyl amides having 1 to 5 carbon atoms, hydroxyethyl methacrylate, mono(meth)acrylates of (poly)ethylene/propylene oxides having an addition molar number of 1 to 30, monovinylether ethylene/propylene oxides having an addition molar number of 1 to 30, and the like.

As described above, the method for preventing scale deposition disclosed herein that comprises adding a scale inhibitor containing the phosphorus-free copolymer described above as the major component to a fluorine-containing water system, can prevent deposition of calcium fluoride and calcium carbonate scales without increasing the phosphorus concentration in the wastewater from a fluorine-containing water system.

The method for preventing scale deposition disclosed herein apparently makes it possible to increase the dispersion efficiency of the scale particles generated in a fluorine-containing water system, as the scale inhibitor used contains ethyl acrylate/vinyl acetate copolymerization constituent units. Apparently as the dispersion efficiency is high, it can keep the generated scale particles smaller in size and thus makes it possible to prevent obstruction on the surface of a membrane, such as a RO membrane, that is used for recovery of the wastewater from the fluorine-containing water system.

The method for preventing scale deposition disclosed herein can be used favorably in water systems for RO membrane treatment, as the copolymer used as the scale inhibitor has a weight-average molecular weight in the range of 1700 to 4000 (favorably 1800 to 3000) and is resistant to gelling.

The method for preventing scale deposition disclosed herein can be integrated as a program into a control unit containing CPUs in a device for control of the treatment of the processed water system (e.g., a personal computer) or a hardware resource containing a recording medium (nonvolatile memory (e.g., USB memory), HDD, CD, or the like) and thus carried out by the control unit.

In the water system to which the scale inhibitor and the method for preventing scale deposition disclosed herein are applied, the water quality condition and the operational condition thereof are not particularly limited.

The method for preventing scale deposition and the scale inhibitor disclosed herein may have the following configurations.

[1] A method for preventing scale deposition, comprising adding a phosphorus-free maleic acid/ethyl acrylate/vinyl acetate copolymer to a fluorine-containing water system.
[2] The method for preventing scale deposition described in [1], wherein the phosphorus-free copolymer is a maleic acid/ethyl acrylate/vinyl acetate ternary copolymer.
[3] The method for preventing scale deposition described in [1] or [2], wherein the phosphorus-free copolymer is prepared by copolymerization of monomer components containing maleic acid at a rate of 60 mol % or more, ethyl acrylate, and vinyl acetate.
[4] The method for preventing scale deposition described in any one of [1] to [3], wherein the phosphorus-free copolymer is prepared by copolymerization of monomer components containing maleic acid at a rate of 60 to 98 mol %, ethyl acrylate at a rate of 1 to 39 mol %, and vinyl acetate at a rate of 1 to 39 mol %.
[5] The method for preventing scale deposition described in any one of [1] to [4], wherein the phosphorus-free copolymer has a weight-average molecular weight of 500 to 5000. The phosphorus-free copolymer preferably has a weight-average molecular weight of 1700 to 4000, more preferably, 1800 to 3000, and still more preferably, 1900 to 2500.
[6] The method for preventing scale deposition described in any one of [1] to [5], wherein the phosphorus-free copolymer is added to a fluorine-containing water system for reverse osmosis membrane treatment.
[7] A scale inhibitor to be added to a fluorine-containing water system, comprising a phosphorus-free maleic acid/ethyl acrylate/vinyl acetate copolymer.
[8] The scale inhibitor described in [7], wherein the phosphorus-free copolymer is a maleic acid/ethyl acrylate/vinyl acetate ternary copolymer.
[9] The scale inhibitor described in [7] or [8], wherein the phosphorus-free copolymer is prepared by copolymerization of monomer components containing maleic acid at a rate of 60 mol % or more, ethyl acrylate, and vinyl acetate.
[10] The scale inhibitor described in any one of [7] to [9], wherein the phosphorus-free copolymer is prepared by copolymerization of monomer components containing maleic acid at a rate of 60 to 98 mol %, ethyl acrylate at a rate of 1 to 39 mol %, and vinyl acetate at a rate of 1 to 39 mol %.
[11] The scale inhibitor described in any one of [7] to [10], wherein the phosphorus-free copolymer has a weight-average molecular weight of 500 to 5000. The phosphorus-free copolymer preferably has a weight-average molecular weight of 1700 to 4000, more preferably, 1800 to 3000, and still more preferably, 1900 to 2500.
[12] The scale inhibitor described in any one of [7] to [11] wherein the phosphorus-free copolymer is added to a fluorine-containing water system for reverse osmosis membrane treatment.
[13] A scale deposition-preventing system comprising a control unit of controlling a fluorine-containing water system so that a phosphorus-free maleic acid/ethyl acrylate/vinyl acetate copolymer is added to the water system.

### EXAMPLES

Hereinafter, advantageous effects of the method for preventing scale deposition and the scale inhibitor disclosed herein will be described specifically with reference to Examples and Comparative Examples.

The scale inhibitors of Examples 1 to 3 and Comparative Examples 1 to 5 were subjected to the tests below, assuming the case where only calcium fluoride scale was formed and also the case where both calcium fluoride and calcium carbonate scales were formed.

### <Calcium Fluoride Deposition-Preventing Test>

500 ml of ultrapure water was placed in a 500-ml conical beaker; calcium chloride was added in an amount of 500 mg^{CaCO3}/L, each of the scale inhibitors used in Examples 1 to 3 and Comparative Examples 1 to 5 described below was added in an amount of 1 mg/L, and sodium fluoride was added in an amount of 50 mg^{F}/L; the mixture was adjusted to pH 7 with a small amounts of aqueous sodium hydroxide and sulfuric acid solutions; after the conical beaker was sealed tightly, it was stirred in a constant-temperature bath at 30° C. for 3 hours. The mixture was then filtered through a filter paper having a pore size of 0.1 μm and the calcium hardness of the filtrate was determined quantitatively by EDTA method.

The water quality condition during the test was as follows: calcium hardness: 500 mg/L, fluorine concentration: 50 mg/L, and pH: 7.

### <Simultaneous Calcium Fluoride and Calcium Carbonate Deposition-Preventing Test>

500 ml of ultrapure water was placed in a 500-ml conical beaker; calcium chloride was added thereto in an amount of 500 mg^{CaCO3}/L, each of the scale inhibitors used in Examples 1 to 3 and Comparative Examples 1 to 5 described below was added in an amount of 2 mg/L, sodium fluoride was added in an amount of 50 mg^{F}/L and sodium bicarbonate was added in an amount of 500 mg^{CaCO3}/L; the mixture was adjusted to pH 8.5 with a small amounts of aqueous sodium hydroxide and sulfuric acid solutions; after the conical beaker was sealed tightly, it was stirred in a constant-temperature bath at 30° C. for 3 hours. The mixture was then filtered through a filter paper having a pore size of 0.1 μm and the calcium hardness of the filtrate was determined quantitatively by EDTA method.

The water quality condition during the test was as follows: calcium hardness: 500 mg/L, fluorine concentration: 50 mg/L, M alkalinity: 500 mg/L, and pH: 8.5.

In each of Examples 1 to 3 and Comparative Examples 1 to 3, a scale inhibitor obtained by polymerizing of the monomer components (composition) shown in Tables 1 and 2 at the molar ratios shown in the Tables was used. The weight-average molecular weights Mw of these scale inhibitors are shown in Tables 1 and 2. Alternatively in Comparative Examples 4 and 5, the monomer was used as the scale inhibitor. The results on calcium hardness, as determined quantitatively in the deposition-preventing test described above using each of the scale inhibitors of Examples and Comparative Examples are summarized in Tables 1 and 2.

The results obtained in the “calcium fluoride deposition-preventing test” are shown in the column of “calcium fluoride” of the Tables, while the results obtained in the “simultaneous calcium fluoride and calcium carbonate deposition-preventing test” are shown in the column of “calcium fluoride+calcium carbonate” in the Tables.

In Tables 1 and 2, MA represents maleic acid; EA represents ethyl acrylate; VA represents vinyl acetate; AA represents acrylic acid; SA represents sulfonic acid; SHMP represents sodium hexametaphosphate; and HEDP represents hydroxyethylidenephosphonic acid (1-hydroxyethylidene-1,1-diphosphonic acid).

TABLE 1

| | | | | | Calcium hardness of filtrate | |
|---|---|---|---|---|---|---|
| | Scale inhibitor | | | | Calcium | Calcium fluoride + |
| | Monomer | | | | fluoride | Calcium carbonate |
| Example | Composition | Molar ratio | Mw | Phosphorus | mg^{CaCO3}/L | mg^{CaCO3}/L |
| 1 | MA/EA/VA | 75/12.5/12.5 | 1700 | none | 498 | 499 |
| 2 | MA/EA/VA | 75/12.5/12.5 | 1900 | none | 499 | 498 |
| 3 | MA/EA/VA | 75/12.5/12.5 | 2300 | none | 497 | 498 |

TABLE 2

| | | | | | Calcium hardness of filtrate | |
|---|---|---|---|---|---|---|
| | Scale inhibitor | | | | Calcium | Calcium fluoride + |
| Comparative | Monomer | | | | fluoride | Calcium carbonate |
| Example | Composition | Molar ratio | Mw | Phosphorus | mg^{CaCO3}/L | mg^{CaCO3}/L |
| 1 | AA | 100 | 3000 | none | 480 | 473 |
| 2 | AA/SA | 90/10 | 3000 | none | 440 | 415 |
| 3 | AA/SA | 80/20 | 13000 | none | 500 | 420 |
| 4 | SHMP | — | — | contained | 502 | 400 |
| 5 | HEDP | — | — | contained | 501 | 450 |

In the case of the scale inhibitors of Examples 1 to 3, the results obtained in the “calcium fluoride deposition-preventing test” and the “simultaneous calcium fluoride and calcium carbonate deposition-preventing test” showed that the calcium hardness of the filtrate was 490 mg/L or more, demonstrating that it was possible to preserve the initial calcium hardness.

It is thus possible, by adding each of the scale inhibitors of Examples 1 to 3 to a water system containing fluorine and calcium, to prevent deposition of calcium fluoride and calcium carbonate scales. Thus, it becomes possible, when a fluorine- and calcium-containing wastewater is recovered using a RO membrane, to prevent effectively deposition of calcium fluoride and calcium carbonate scales on the surface of the RO membrane.

In the case of the scale inhibitors of Comparative Examples 1 and 2, the results obtained in the “calcium fluoride deposition-preventing test” and the “simultaneous calcium fluoride and calcium carbonate deposition-preventing test” showed that the calcium hardness of the filtrate was smaller than 490 mg/L, indicating that it was not possible to prevent deposition of calcium fluoride. It seems that the scale inhibitors of Comparative Examples 1 and 2, could not prevent deposition of calcium fluoride scale, as it did not contain maleic acid.

In the case of the scale inhibitors of Comparative Examples 3 to 5, the results obtained in the “simultaneous calcium fluoride and calcium carbonate deposition-preventing test” showed that the calcium hardness of the filtrate was smaller than 490 mg/L, indicating that it was not possible to prevent deposition of calcium fluoride and calcium carbonate scales, when calcium fluoride and calcium carbonate deposited simultaneously.

The results above show that a maleic acid/ethyl acrylate/vinyl acetate terpolymer containing maleic acid at a rate of 60 mol % or more and having a molecular weight of 500 to 5000 can prevent deposition of calcium fluoride and calcium carbonate scales. Accordingly, for example when a fluorine- and calcium-containing wastewater is recovered using a RO membrane, it is possible to prevent deposition of calcium fluoride and calcium carbonate scales on the surface of RO membrane effectively, and thus carry out the RO membrane operation reliably.

1. A method for preventing scale deposition comprising adding a phosphorus-free maleic acid/ethyl acrylate/vinyl acetate copolymer to a fluorine-containing water system.

2. The method for preventing scale deposition according to claim 1, wherein the copolymer is a polymer prepared by copolymerization of monomer components containing maleic acid at a rate of 60 mol % or more, ethyl acrylate, and vinyl acetate.

3. The method for preventing scale deposition according to claim 1, wherein the copolymer has a weight-average molecular weight of 500 to 5000.

4. The method for preventing scale deposition according to claim 1, wherein the copolymer is added to a fluorine-containing water system for reverse osmosis membrane treatment.

5. A scale inhibitor to be added to a fluorine-containing water system, comprising a phosphorus-free maleic acid/ethyl acrylate/vinyl acetate copolymer.
